(19) United States
(12) Patent Application Publication
(10) Pub. No.: US 2009/0279219 A1
(43) Pub. Date: Nov. 12, 2009

(54) ELECTROSTATIC DISCHARGE PROTECTION CIRCUIT AND ELECTRONIC SYSTEM UTILIZING THE SAME

(75) Inventor: Cheng-Huang Yu, Guanyin Township (TW)

Correspondence Address: LIU & LIU, 444 S. FLOWER STREET, SUITE 1750, LOS ANGELES, CA, 90071, US

(73) Assignee: TPO DISPLAYS CORP.

(21) Appl. No.: 12/436,699

(22) Filed: May 6, 2009

(30) Foreign Application Priority Data
May 9, 2008 (TW) 097117145

(51) Int. Cl. H02H 9/04

(52) U.S. Cl. 361/56

(57) ABSTRACT

ESD protection circuit coupled to an input/output pad and including an attenuation unit and a discharge unit is provided. The attenuation unit attenuates an electrostatic discharge current for generating an attenuated current. The discharge unit releases the attenuated current.

### CROSS REFERENCE TO RELATED APPLICATIONS

This Application claims priority of Taiwan Patent Application No. 097117145, filed on May 9, 2008, the entirety of which is incorporated by reference herein.

### BACKGROUND OF THE INVENTION

1. Field of the Invention

The invention relates to a protection circuit, and more particularly to an electrostatic discharge (ESD) protection circuit.

2. Description of the Related Art

With the development of semiconductor manufacturing, electrostatic discharge (ESD) protection has become one of the most critical reliability issues for integrated circuits (IC). Several ESD test modes, such as machine mode (MM) or human body mode (HBM), have been proposed to imitate the circumstances under which ESD occurs. The ability to withstand certain levels of ESD is essential for successful commercialization of an IC.

ESD protection is also a critical reliability issue for integrated circuits (IC). In particular, as the semiconductor process advances into the deep sub-micron stage, scaled-down devices and thinner gate oxides are more vulnerable to ESD stress. Generally, the input/output pads on IC chips must sustain at least 2 kVolt ESD of high stress from a Human Body Mode (HBM) or 200V from a Machine Mode. Thus, the input/output pads on IC chips usually include ESD protection devices or circuits protecting the core circuit from ESD damage.

### BRIEF SUMMARY OF THE INVENTION

Electrostatic discharge (ESD) protection circuits are provided. An exemplary embodiment of an ESD protection circuit, which is coupled to an input/output pad, comprises an attenuation unit and a discharge unit. The attenuation unit attenuates an ESD current for generating an attenuated current. The discharge unit releases the attenuated current.

Electronic systems are also provided. An exemplary embodiment of an electronic system comprises an input/output pad, a core circuit, and an ESD protection circuit. The ESD protection circuit is coupled to the input/output pad and comprises an attenuation unit and a discharge unit. The attenuation unit attenuates an ESD current for generating an attenuated current. The discharge unit releases the attenuated current.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1 is a schematic diagram of an exemplary embodiment of an electronic system;

FIG. 2 is a schematic diagram of an exemplary embodiment of an electrostatic discharge protection circuit; and

FIG. 3 is a schematic diagram of another exemplary embodiment of the electrostatic discharge protection circuit.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

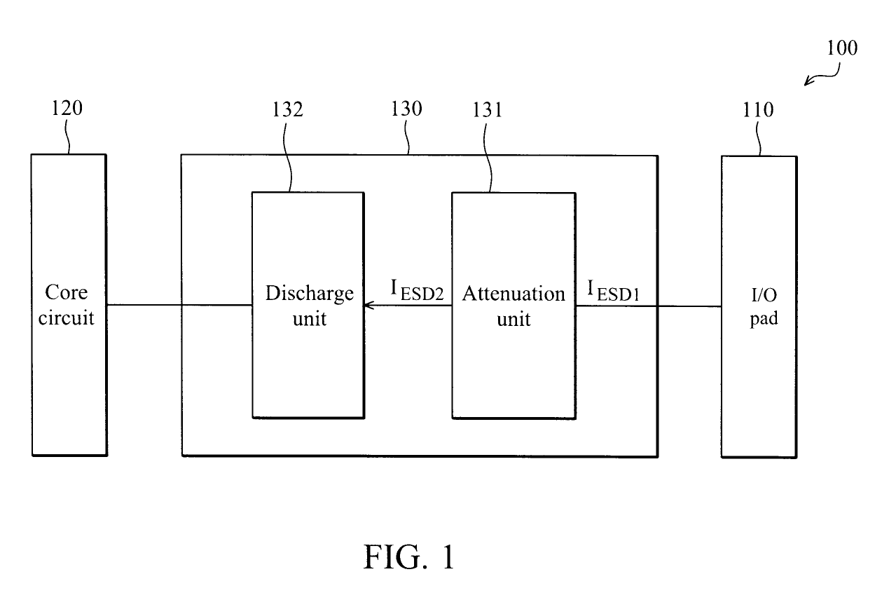

FIG. 1 is a schematic diagram of an exemplary embodiment of an electronic system. The electronic system 100 can be a personal digital assistant (PDA), a cellular phone, a digital camera (DSC), a television, a global positioning system (GPS), a car display, an avionics display, a digital photo frame, a notebook computer (NB), or a personal computer (PC). In this embodiment, the electronic system 100 comprises an input/output (I/O) pad 110, a core circuit 120, and an ESD protection circuit 130.

The I/O pad 110 is capable of receiving signal from an external circuit (not shown) or transmitting signals to the external circuit. The core circuit 120 executes related functions. For example, if the core circuit 120 is a panel circuit, the related functions relate to display image. If the core circuit 120 is a DC-DC converter, the related functions relate to transform voltage level.

The ESD protection circuit 130 is coupled between the I/O pad 110 and the core circuit 120. The ESD protection circuit 130 releases an ESD current from the I/O pad 110 such that the core circuit 120 is not damaged by the ESD current. In this embodiment, the ESD protection circuit 130 comprises an attenuation unit 131 and a discharge unit 132. The attenuation unit 131 attenuates an ESD current I_{ESD1} to generate an attenuated current I_{ESD2}. The discharge unit 132 releases the attenuated current I_{ESD2} such that the core circuit 120 is not damaged by the attenuated current I_{ESD2}.

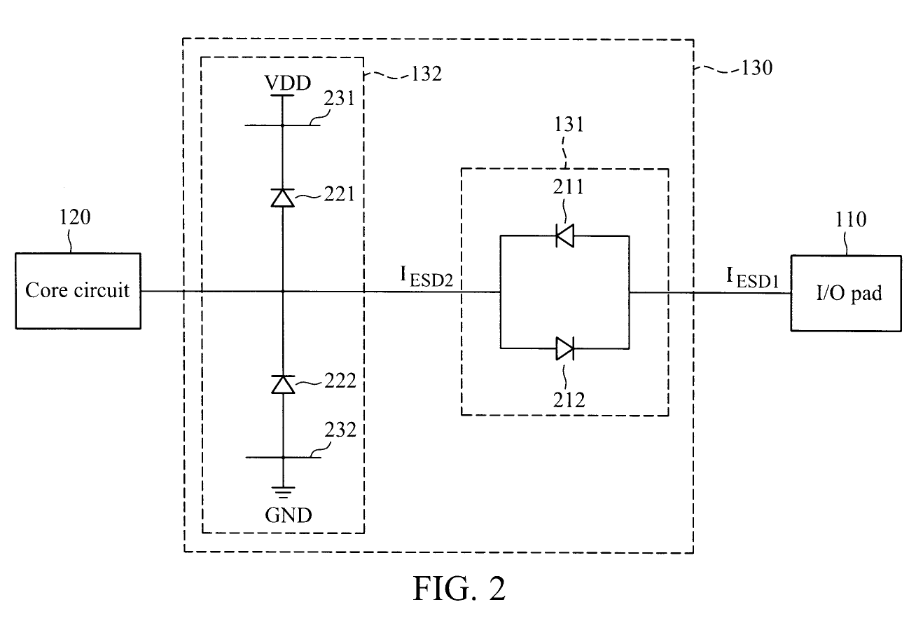

FIG. 2 is a schematic diagram of an exemplary embodiment of the ESD protection circuit. The attenuation unit 131 comprises a diode ring. The diode ring is coupled between the I/O pad 110 and the discharge unit 132. In this embodiment, the diode ring comprises diodes 211 and 212. The cathode of the diode 211 is coupled to the discharge unit 132. The anode of the diode 211 is coupled to the I/O pad 110. The cathode of the diode 212 is coupled to the I/O pad 110. The anode of the diode 212 is coupled to the discharge unit 132.

When the ESD voltage of the I/O pad 110 is positive, the diode 211 is turned on to attenuate the ESD current I_{ESD1}. Similarly, when the ESD voltage of the I/O pad 110 is negative, the diode 212 is turned on. When the diode is turned on, an equivalent impedance is generated. The equivalent impedance of the diode causes the impedance of a trace to increase. Thus, the current through the trace can be attenuate.

In this embodiment, the equivalent impedance of the attenuation unit 131 is 1 to 10000 ohm, 200 to 2000 ohm, or 300 to 600 ohm. For example, if the diode is turned on, the equivalent impedance is approximately 500 ohm. Thus, the attenuated current I_{ESD2} is approximately 3.24 A when the ESD current I_{ESD1} is 7.63 A. The attenuation ratio is approximately 57.81%. When the ESD current I_{ESD1} is −8.28 A, the attenuated current I_{ESD2} is approximately −3.4 A. The attenuation ratio is approximately 58.93%.

Additionally, in this embodiment, the discharge unit 132 comprises diodes 221 and 222. The diodes 221 and 222 are connected in serial between power lines 231 and 232. In a normal mode (the ESD event does not occur), the power line 231 receives a high operation voltage VDD and the power line 232 receives a low operation voltage GND. When an ESD event occurs in the I/O pad 110, the attenuated current I_{ESD2} is released to the power line 231 or 232 via the diode 221 or 222. Thus, the ESD current does not enter the core circuit 120.

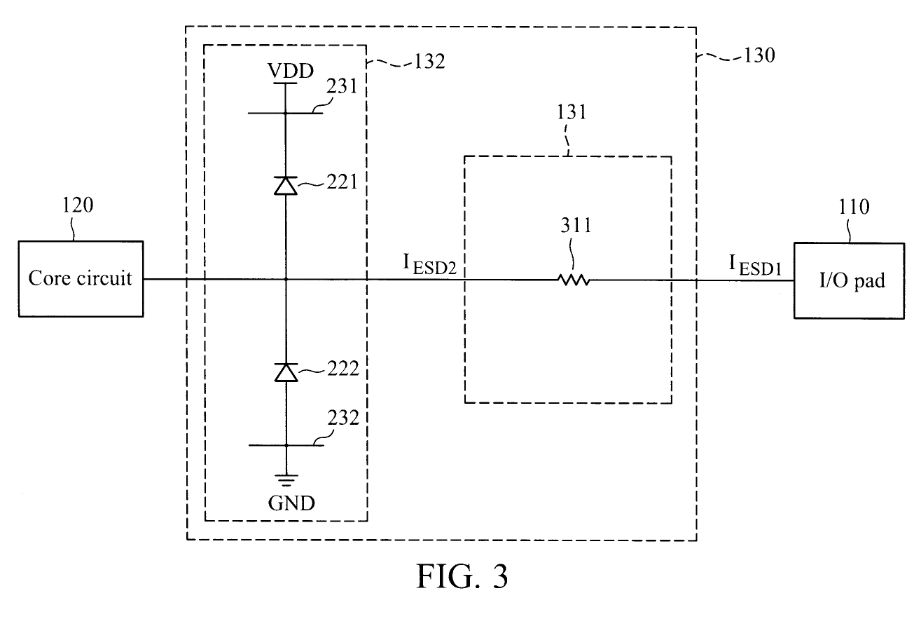

FIG. 3 is a schematic diagram of another exemplary embodiment of the ESD protection circuit. FIG. 3 is similar FIG. 2 with the exception that the attenuation unit 131 is a resistor 311. The impedance of the resistor 311 is controlled to control the attenuation level. For example, if the ESD current I_{ESD1} is fixed, when the impedance of the resistor 311 is increased, the attenuated current I_{ESD2} generated by the attenuation unit 131 is reduced. In other embodiments, the attenuation unit 131 can be replaced by other elements, such as a metal-oxide semiconductor (MOS) transistor.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electrostatic discharge protection circuit coupled to an input/output pad, comprising:
an attenuation unit attenuating an electrostatic discharge current for generating an attenuated current; and
a discharge unit releasing the attenuated current.

2. The electrostatic discharge protection circuit as claimed in claim 1, wherein the attenuation unit comprises a diode ring coupled between the input/output pad and the discharge unit.

3. The electrostatic discharge protection circuit as claimed in claim 2, wherein the diode ring comprises:
a first diode comprising a cathode coupled to the discharge unit and an anode coupled to the input/output pad; and
a second diode comprising a cathode coupled to the input/output pad and an anode coupled to the discharge unit.

4. The electrostatic discharge protection circuit as claimed in claim 1, wherein the attenuation unit is a resistor coupled between the input/output pad and the discharge unit.

5. The electrostatic discharge protection circuit as claimed in claim 1, wherein the attenuation unit is a metal-oxide semiconductor (MOS) transistor coupled between the input/output pad and the discharge unit.

6. The electrostatic discharge protection circuit as claimed in claim 1, wherein an equivalent impedance of the attenuation unit is 200 ohm to 2000 ohm.

7. An electronic system, comprising:
an input/output pad;
a core circuit; and
an electrostatic discharge protection circuit coupled between the input/output pad and the core circuit, and comprising:
an attenuation unit attenuating an electrostatic discharge current for generating an attenuated current; and
a discharge unit releasing the attenuated current.

8. The electronic system as claimed in claim 7, wherein the attenuation unit comprises a diode ring and the diode ring is coupled between the input/output pad and the discharge unit.

9. The electronic system as claimed in claim 8, wherein the diode ring comprises:
a first diode comprising a cathode coupled to the discharge unit and an anode coupled to the input/output pad; and
a second diode comprising a cathode coupled to the input/output pad and an anode coupled to the discharge unit.

10. The electronic system as claimed in claim 7, wherein the attenuation unit is a resistor coupled between the input/output pad and the discharge unit.

11. The electronic system as claimed in claim 7, wherein the attenuation unit is a metal-oxide semiconductor (MOS) transistor coupled between the input/output pad and the discharge unit.

12. The electronic system as claimed in claim 7, wherein an equivalent impedance of the attenuation unit is 200 ohm to 2000 ohm.

13. The electronic system as claimed in claim 7, wherein the core circuit is a panel circuit.

14. The electronic system as claimed in claim 7, wherein the electronic system is a personal digital assistant (PDA), a cellular phone, a digital camera (DSC), a television, a global positioning system (GPS), a car display, an avionics display, a digital photo frame, a notebook computer (NB), or a personal computer (PC).
